(19) United States
(12) Patent Application Publication
(10) Pub. No.: US 2021/0206698 A1
(43) Pub. Date: Jul. 8, 2021

(54) METHOD FOR PRODUCING A MICROBIAL-ENHANCED ORGANIC LIQUID FERTILIZER FOR HYDROPONICS CULTIVATION

(71) Applicant: Nano and Advanced Materials Institute Limited, Hong Kong (CN)

(72) Inventors: Sik Chun Johnny LO, Hong Kong (CN); Kwan Wing CHEU, Hong Kong (CN); Tong GUO, Hong Kong (CN); Kin Hang Ken NG, Hong Kong (CN)

(21) Appl. No.: 17/247,513

(22) Filed: Dec. 15, 2020

Related U.S. Application Data
(60) Provisional application No. 62/956,677, filed on Jan. 3, 2020.

(51) Int. Cl. C05F 17/50; C05F 17/40; C05F 17/20; C05F 17/10; C05G 5/23

(52) U.S. Cl. CPC C05F 17/50; C05F 17/40; C05G 5/23; C05F 17/10; C05F 17/20

(57) ABSTRACT

The present invention relates to the application of soilless cultivation such hydroponics or aquaponics cultivation. More particularly, the present invention relates to a method for producing a microbial-enhanced organic liquid fertilizer for hydroponic cultivation and a bioreactor system for producing the same. The method relates to produce high productivity and highly effective organic liquid fertilizer by using the bioreactor system.

### CROSS-REFERENCE TO RELATED APPLICATIONS

This application claims the benefit of U.S. Provisional Patent Application No. 62/956,677, filed on Jan. 3, 2020, which is incorporated by reference herein in its entirety.

### TECHNICAL FIELD

The present disclosure generally relates to a method for producing a microbial-enhanced organic liquid fertilizer for hydroponics cultivation.

### BACKGROUND ART

Conventional hydroponic systems cannot use organic fertilizer, which inhibits plant growth since organic compounds contained in hydroponic solutions have been regarded as phytotoxic (which implies a toxic effect by a compound(s) on plant growth). This is because organic nitrogen (protein and amino acids) in organic fertilizers are unable to be released into plant-available nutrients (nitrates and ammonium) in conventional hydroponics system, accumulation of organic compounds in high concentration leads to the phytotoxic effects. However, it is important to develop methods capable of using organic fertilizer sources in hydroponics from the viewpoint of growing organic vegetables crops and other plants, which is widely regarded as more environmentally friendly.

To enable organic liquid fertilizer to be used directly in hydroponics system without phytotoxic effects to cultivating plants, microorganisms are required to carry out chemical/biochemical process to change organic compounds in organic liquid fertilizer to nutrients which can easily be utilized by plants. To achieve this goal, this invention aims to design and develop a high productivity bioreactor system which can produce highly effective organic liquid fertilizer for hydroponics cultivation. This requires high microorganism loading capacity and optimal conditions for high microbial functions, such as generate nitrate from organic nitrogen and solubilize phosphates from insoluble phosphorous sources. Considering the application, the bioreactor system should be easy to manufacture and operate.

A need therefore exists for a method for producing an organic liquid fertilizer for hydroponics cultivation to eliminate or at least diminish the disadvantages and problems described above.

### SUMMARY OF THE INVENTION

Provided herein is a method for producing a microbial-enhanced organic liquid fertilizer for hydroponic cultivation comprising: providing a nitrification bioreactor comprising a first medium solution containing nitrifying bacteria; adding an amount of a first organic fertilizer comprising organic nitrogen into the first medium solution thereby forming a first fertilizer mixture; oxidizing the organic nitrogen in the first fertilizer mixture to nitrates by the nitrifying bacteria thereby forming a nitrate-rich fertilizer solution; providing a phosphorus solubilization bioreactor comprising a second medium solution containing phosphorus-solubilizing microorganisms; adding an amount of a second organic fertilizer comprising insoluble phosphorus into the second medium solution thereby forming a second fertilizer mixture; converting the insoluble phosphorus in the second fertilizer mixture into soluble phosphates by the phosphorus-solubilizing microorganisms thereby forming a soluble-phosphate-rich fertilizer solution; mixing the nitrate-rich fertilizer solution and the soluble-phosphate-rich fertilizer solution thereby forming a liquid fertilizer mixture; and adjusting pH of the liquid fertilizer mixture to a pH value between 5.8 and 6.5 thereby forming the microbial-enhanced organic liquid fertilizer.

In certain embodiments, the first organic fertilizer is in a form of liquid or solid, comprises livestock excrements, poultry excrements, by-products of food, animal products, fermented leftover food, guano, algae or a combination thereof and has a concentration of organic nitrogen between 5% wt and 10% wt.

In certain embodiments, the organic nitrogen comprises proteins, amino acids, ammonia, or a combination thereof.

In certain embodiments, the nitrifying bacteria comprise Oxalobacteraceae, Nitrospiraceae, Nitrosomonadaceae, Comanmonadaceae, or a combination thereof.

In certain embodiments, the first fertilizer mixture has a pH value between 6 and 8 and a temperature between 20° C. and 30° C.

In certain embodiments, the method further comprises adding an amount of the first organic fertilizer into the first fertilizer mixture for at least one time at different time intervals.

In certain embodiments, the nitrification reactor further comprises a pH buffer for keeping pH of the first fertilizer mixture at a pH value between 6 and 8 and a bio-carrier for inhabiting and growing the nitrifying bacteria.

In certain embodiments, the second organic fertilizer is in a form of liquid or solid, comprises a bone meal, a fish bone, a phosphate rock, or a combination thereof and has a concentration of insoluble phosphorus between 15% wt and 30% wt.

In certain embodiments, the phosphorus-solubilizing microorganisms comprise Bacillus megaterium, Bacillus subtilis, Bacillus cereus, or a combination thereof.

In certain embodiments, the second fertilizer mixture has a pH value between 4.0 and 5.5 and a temperature between 20° C. and 30° C.

In certain embodiments, the step of adjusting pH of the liquid fertilizer mixture comprises adding a pH adjusting material into the liquid fertilizer mixture.

In certain embodiments, the pH adjusting material is baking soda or slaked lime.

Provided herein is a method for producing a microbial-enhanced organic liquid fertilizer for hydroponic cultivation comprising: providing a nitrification bioreactor comprising a first medium solution containing nitrifying bacteria; adding an amount of a first organic fertilizer comprising organic nitrogen into the first medium solution thereby forming a first fertilizer mixture; oxidizing the organic nitrogen in the first fertilizer mixture to nitrates by the nitrifying bacteria thereby forming a nitrate-rich fertilizer solution; adding an amount of a second organic fertilizer comprising insoluble phosphorus into the nitrate-rich fertilizer solution thereby forming a second fertilizer mixture; converting the insoluble phosphorus in the second fertilizer mixture into soluble phosphates thereby forming a liquid fertilizer mixture; and adjusting pH of the liquid fertilizer mixture to a pH value between 5.8 and 6.5 thereby forming the microbial-enhanced organic liquid fertilizer.

In certain embodiments, the first organic fertilizer is in a form of liquid or solid, comprises livestock excrements, poultry excrements, by-products of food, animal products, fermented leftover food, guano, algae or a combination thereof and has a concentration of organic nitrogen between 5% wt and 10% wt.

In certain embodiments, the organic nitrogen comprises proteins, amino acids, ammonia, or a combination thereof.

In certain embodiments, the nitrifying bacteria comprise Oxalobacteraceae, Nitrospiraceae, Nitrosomonadaceae, Comanmonadaceae, or a combination thereof.

In certain embodiments, the first fertilizer mixture has a pH value between 6 and 8 and a temperature between 20° C. and 30° C.

In certain embodiments, the method further comprises adding an amount of the first organic fertilizer into the first fertilizer mixture for at least one time at different time intervals.

In certain embodiments, the nitrification reactor further comprises a pH buffer for keeping pH of the first fertilizer mixture at a value between 6 and 8 and a bio-carrier for inhabiting and growing the nitrifying bacteria.

In certain embodiments, the second organic fertilizer is in a form of liquid or solid, comprises a bone meal, a fish bone, a phosphate rock, or a combination thereof and has a concentration of insoluble phosphorus between 15% wt and 30% wt.

In certain embodiments, the step of adding an amount of a second organic fertilizer into the nitrate-rich fertilizer is performed when the nitrate-rich fertilizer solution has a pH value between 5.0 and 5.5.

In certain embodiments, the method further comprises: adjusting pH of the second fertilizer mixture to a pH value between 6.0 and 6.5; and adding an amount of the first organic fertilizer to the second fertilizer mixture.

In certain embodiments, the step of adjusting pH of the second fertilizer mixture comprises adding a pH adjusting material into the second fertilizer mixture.

In certain embodiments, the step of adjusting pH of the liquid fertilizer mixture comprises adding a pH adjusting material into the liquid fertilizer mixture.

In certain embodiments, the pH adjusting material is carolite.

These and other aspects, features and advantages of the present disclosure will become more fully apparent from the following brief description of the drawings, the drawings, the detailed description of certain embodiments and appended claims.

### BRIEF DESCRIPTION OF DRAWINGS

The appended drawings contain figures of certain embodiments to further illustrate and clarify the above and other aspects, advantages and features of the present invention. It will be appreciated that these drawings depict embodiments of the invention and are not intended to limit its scope. The invention will be described and explained with additional specificity and detail through the use of the accompanying drawings in which:

FIG. 1 is a flow chart depicting a method for producing a microbial-enhanced organic liquid fertilizer for hydroponic cultivation according to certain embodiments;

FIG. 2 is a flow chart depicting a method for producing a microbial-enhanced organic liquid fertilizer for hydroponic cultivation according to certain embodiments;

FIG. 3 shows NO₃—N changes with microorganic sources of seawater, soil, compost and aged aquarium water as the inoculum respectively;

FIG. 4A shows the setup of a nitrification bioreactor for mineralization of organic nitrogen in organic liquid fertilizer into nitrate according to certain embodiments;

FIG. 4B shows the setup of a phosphorus solubilization bioreactor according to certain embodiments;

FIG. 5 shows the change of the concentration of NO₃—N in the mineralization solution for mineralization with air flow rates of 1.0 nl/m, 3.0 nl/m and 5.0 nl/m respectively during the mineralization process;

FIG. 6 shows the change of the concentration of NH₃—N in the mineralization solution for mineralization with air flow rates of 1.0 nl/m, 3.0 nl/m and 5.0 nl/m respectively during the mineralization process;

FIG. 7 shows the dissolved oxygen level of the mineralization solution for mineralization with air flow rates of 1.0 nl/m, 3.0 nl/m and 5.0 nl/m respectively during the mineralization process;

FIG. 8 shows the change of the concentration of NO₃—N in the mineralization solution for mineralization with 0.5 bags, 1 bag and 1.5 bags of bio-carriers respectively during the mineralization process;

FIG. 9 shows the change of the concentration of NH₃—N in the mineralization solution for mineralization with 0.5 bags, 1 bag and 1.5 bags of bio-carriers respectively;

FIG. 10 shows the change of concentration of NO₃—N and NH₃—N during the period of nitration;

FIG. 11 shows growth of local lettuces;

FIG. 12A shows average height records of local lettuces during the growth period using chemical fertilizer (CF, square), OLF (triangle) and undigested OLF (rhombus) respectively;

FIG. 12B shows average crown width records of local lettuces during the growth period using chemical fertilizer (CF, square), OLF (triangle) and undigested OLF (rhombus) respectively;

FIG. 13 shows total macro nutrients consumption rate of local lettuces using chemical fertilizer (CF, blue square), OLF (red triangle) and undigested OLF (green rhombus) respectively;

FIG. 14 is a flow chart depicting a method for producing a microbial-enhanced organic liquid fertilizer for hydroponic cultivation according to certain embodiments;

FIG. 15 is a flow chart depicting a method for producing a microbial-enhanced organic liquid fertilizer for hydroponic cultivation according to certain embodiments;

FIG. 16 shows the change of pH and dissolved phosphorus content during 25 days of simultaneous phosphorus solubilization and nitrification;

FIG. 17 shows the change of nitrate-N content during 25 days of simultenuous phosphorus solubilization and nitrification;

FIG. 18A is a photo of roots grown at pH 6.0-6.5; and

FIG. 18B is a photo of roots grown at pH 5.5-5.8.

### DETAILED DESCRIPTION OF THE INVENTION

It is an object of this invention to provide a high productivity bioreactor system which can produce highly effective organic liquid fertilizer for hydroponics cultivation. The bioreactor is designed to accept both liquid and solids raw materials and convert it into soluble organic nutrients which can easily utilized in hydroponics cultivation. The bioreactor has two main functions: to convert organic nitrogen into nitrates and to convert insoluble phosphorous sources into soluble phosphates.

The present disclosure provides a method for producing a highly effective organic liquid fertilizer for hydroponics cultivation. The method accepts both liquid and solid raw materials and converts them into soluble organic nutrients which can be easily utilized in hydroponics cultivation. The method uses a bioreactor system to convert organic nitrogen into nitrates and to convert insoluble phosphorous sources into soluble phosphates.

The present invention enables organic liquid fertilizer to be used directly in hydroponics system without phytotoxic effects to cultivating plants. The present invention relates to a design of a bioreactor system which control microorganisms to carry out chemical/biochemical process to change organic compounds in organic liquid fertilizer to nutrients which can easily be utilized by plants, such as generate nitrate from organic nitrogen and solublize phosphates from insoluble phosphorous sources.

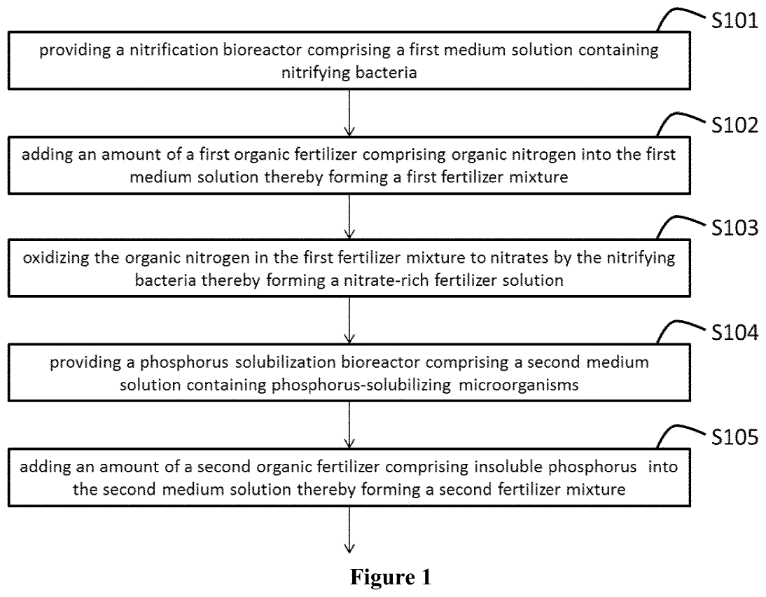

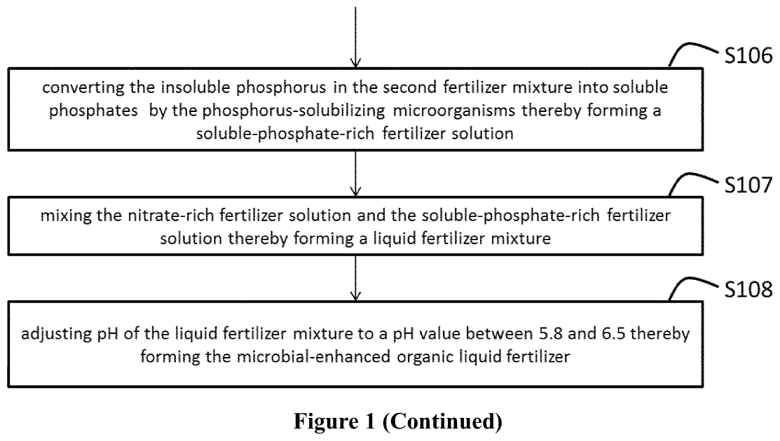

FIG. 1 is a flow chart depicting a method for producing a microbial-enhanced organic liquid fertilizer for hydroponic cultivation according to certain embodiments. In step S101, a nitrification bioreactor comprising a first medium solution containing nitrifying bacteria is provided. In step S102, an amount of a first organic fertilizer comprising organic nitrogen is added into the first medium solution thereby forming a first fertilizer mixture. In step S103, the organic nitrogen in the first fertilizer mixture is oxidized to nitrates by the nitrifying bacteria thereby forming a nitrate-rich fertilizer solution. In step S104, a phosphorus solubilization bioreactor comprising a second medium solution containing phosphorus-solubilizing microorganisms is provided. In step S105, an amount of a second organic fertilizer comprising insoluble phosphorus is added into the second medium solution thereby forming a second fertilizer mixture. In step S106, the insoluble phosphorus in the second fertilizer mixture is converted into soluble phosphates by the phosphorus-solubilizing microorganisms thereby forming a soluble-phosphate-rich fertilizer solution. In step S107, the nitrate-rich fertilizer solution and the soluble-phosphate-rich fertilizer solution are mixed thereby forming a liquid fertilizer mixture. In step S108, a pH adjusting material is added into the liquid fertilizer mixture for adjusting pH of the liquid fertilizer mixture to a pH value between 5.8 and 6.5 thereby forming the microbial-enhanced organic liquid fertilizer.

In certain embodiments, the first organic fertilizer is in a form of liquid or solid.

In certain embodiments, the first organic fertilizer comprises livestock excrements, poultry excrements, by-products of food, animal products, fermented leftover food, guano, algae or a combination thereof.

In certain embodiments, the first organic fertilizer has a concentration of organic nitrogen between 5% wt and 10% wt.

In certain embodiments, the organic nitrogen comprises proteins, amino acids, ammonia, or a combination thereof.

In certain embodiments, the nitrifying bacteria comprise Oxalobacteraceae, Nitrospiraceae, Nitrosomonadaceae, Comanmonadaceae, or a combination thereof.

In certain embodiments, the first fertilizer mixture has a pH value between 6 and 8.

In certain embodiments, the first fertilizer mixture has a temperature between 20° C. and 30° C.

In certain embodiments, the methods further comprises adding an amount of the first organic fertilizer into the first fertilizer mixture for at least one time at different time intervals.

In certain embodiments, the nitrification reactor further comprises a pH buffer for keeping pH of the first fertilizer mixture at a pH value between 6 and 8.

In certain embodiments, the nitrification reactor further comprises a bio-carrier for inhabiting and growing the nitrifying bacteria.

In certain embodiments, the second organic fertilizer is in a form of liquid or solid.

In certain embodiments, the second organic fertilizer comprises a bone meal, a fish bone, a phosphate rock, or a combination thereof.

In certain embodiments, the second organic fertilizer has a concentration of insoluble phosphorus between 15% wt and 30% wt.

In certain embodiments, the phosphorus-solubilizing microorganisms comprise Bacillus megaterium, Bacillus subtilis, Bacillus cereus, or a combination thereof.

In certain embodiments, the second fertilizer mixture has a pH value between 4.0 and 5.5.

In certain embodiments, the second fertilizer mixture has a temperature between 20° C. and 30° C.

In certain embodiments, the step of adjusting pH of the liquid fertilizer mixture comprises adding a pH adjusting material into the liquid fertilizer mixture.

In certain embodiments, the pH adjusting material is baking soda or slaked lime.

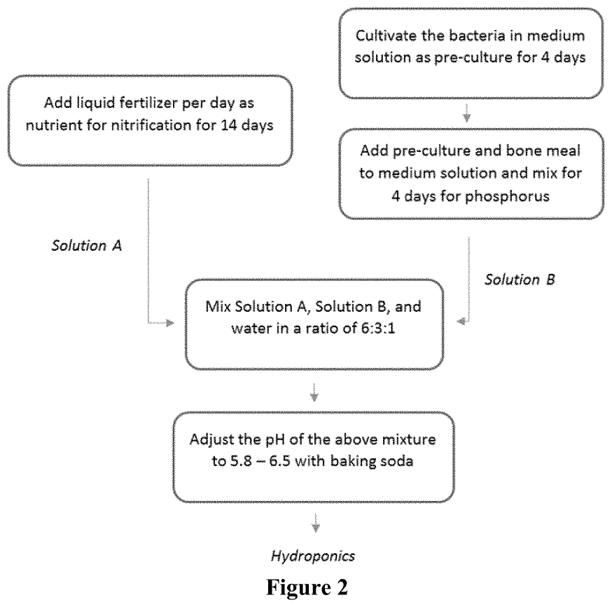

FIG. 2 is a flow chart depicting a method for producing a microbial-enhanced organic liquid fertilizer for hydroponic cultivation according to certain embodiments. This method is directed to production of nitrate-rich solution, Solution A, and soluble-phosphate-rich solution, Solution B, and their combination for use in hydrophonics. First, liquid fertilizer is added per day as nutrient for nitrification for 14 days to form Solution A. The phosphorus-solubilizing microorganisms are cultivated in a medium solution as pre-culture for 4 days. The pre-culture and bone meal are added to medium solution and mix for 4 days for phosphorus to form Solution B. Solution A, Solution B, and water are mixed in a ratio of 6:3:1. The pH of the above mixture is adjusted to 5.8-6.5 with baking soda to form the microbial-enhanced organic liquid fertilizer for use in hydrophonics.

In certain embodiments, since excess nitrogen content in water would deplete dissolved oxygen and undigested nitrogen content in the form of ammonia would escape to the atmosphere, the nitrogen content has to be added gradually, i.e. 25-50 mg/L per day. Therefore, it requires that the nitrogen source has a high nitrogen content such that the volume of the nitrification medium during the period of nitrification would remain almost constant with the gradual addition of nitrogen source. Nitrogen sources with nitrogen contents of 5-10% are chosen such that the addition of them would lead to less than 1% increase in the volume of the nitrification medium for the addition of 25 mg/L of nitrogen content per day for 14 days.

In certain embodiments, the nitrogen contents in nitrogen sources are in various forms such as ammonia and amino acids. Nitrogen content in the form of ammonia is more readily digested compared to other forms. Therefore, nitrogen sources with nitrogen contents comprising above 10% ammonia are preferred.

In certain embodiments, nitrification is favored at pH 7.0-8.0, while being limited at pH below 6.0. Different nitrogen sources have a variety of pH values due to the differences in raw materials and production processes. Nitrogen sources with pH above 6.5 are acceptable since their addition would not lower the pH of the nitrification medium to a level that inhibits nitrification. Alkaline nitrogen sources which have pH greater than 8.0 are preferred since their addition could help to balance the protons released during nitrification.

### Example 1

In this example, different microorganism sources were studied to find out an appropriate source of microorganisms for mineralization of organic nitrogen in organic liquid fertilizer into nitrates. A short list of microorganism sources was listed as follows: Seawater, Soil, Compost, aged aquarium water, presumably contains the genera Nitrosomonas and Nitrobacter responsible for the oxidation of ammonia and nitrite respectively

A single microorganism source (150 mL) was added to 250-mL conical flasks containing DI water as inoculum. Equal numbers of bio-carriers were added to each flask. To avoid introducing uncertainties NH₃ solution was used as nitrogen source instead of organic liquid fertilizers. 28% NH₃ solution (0.05 mL) was added to each flask initially. Flasks were shaken (120 strokes/min) for 23 days at 27° C. Nitrate-N(NO₃—N) and ammonia-N(NH₃—N) concentration were then determined.

4 individual experiments were carried out with each of the above sources according to the amount of inoculum used. 0.75 g of each of soil and compost was added to 150 mL DI water, while 150 mL of each of seawater and aged aquarium water was used.

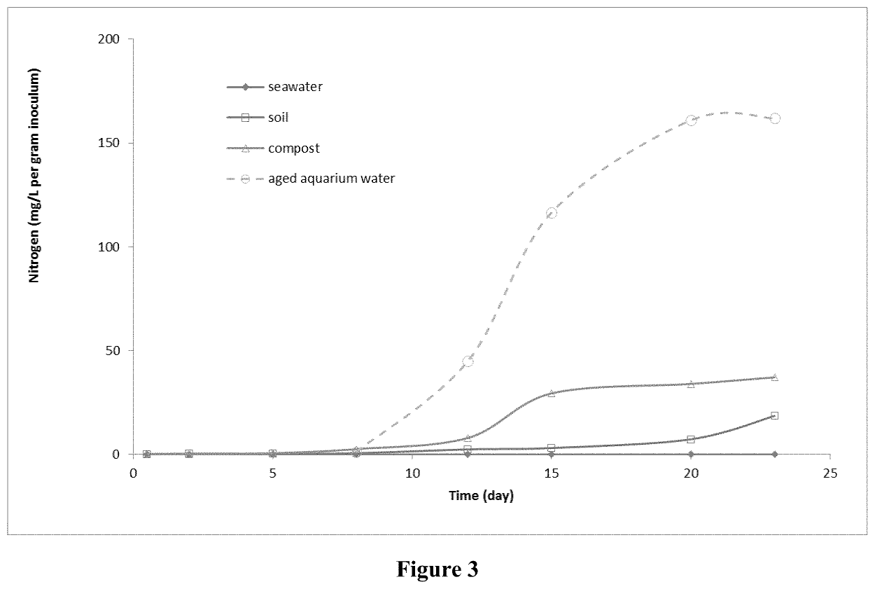

As shown in FIG. 3, for microorganism source of aged aquarium water, starting from day 8 the concentration of NO₃—N increased sharply and reached to 162 ppm per gram inoculum at day 23. NO₃—N started to increase from day 8 for microorganism source of compost while started from day 12 for microorganism source of soil and then reached to 37 ppm and 19 ppm respectively at day 23. No significant increase of NO₃—N was found in microorganism source of seawater. Thus, nitrification efficiency results were: aged aquarium water (161.9 ppm)>compost (37.2 ppm)>soil (18.6 ppm)>seawater (<0.1 ppm), aged aquarium water was used as the microorganism source for the bioreactor for nitration.

### Example 2

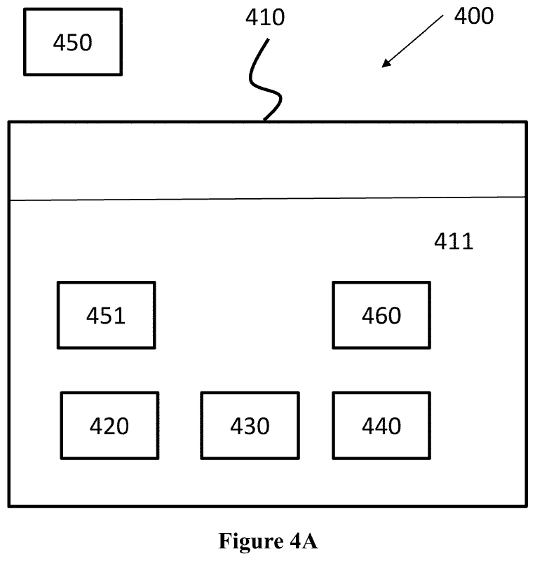

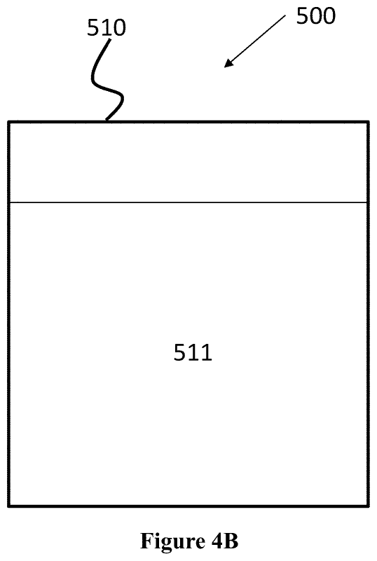

A nitrification bioreactor 400 for nitration was produced as shown in FIG. 4A and includes the following components: a glass tank 410 (D 22 cm×W 35 cm×H 41 cm), as the container of the mineralization process; 22 L tap water 411 as the medium of mineralization; 800 g of moistened bio-carriers 420 for the inhabitation and growth of the nitrifying bacteria; nitrifying bacteria, the genera Nitrosomonas and Nitrobacter, responsible for the oxidation of ammonia and nitrite respectively; 740 g of carolite 430 for buffering pH value between 7-8 of the tank water (i.e. 34 g of carolite for 1 L of water); a wave-maker 440 for generating circulation (1585 gallon per hour (GPH)) in the tank water 410; an air pump 450 supplying air through an air stone 451 to the tap water 411 at a flow rate of 3 nl/m to keep the dissolved oxygen level in the water high for the aerobic mineralization process; a heater 460 for keeping the water at 28-30° C.

The nitrification bioreactor 400 was initiated by adding 1-1.5 mL ammonia solution (28%) daily, excluding weekend and public holiday, in order to stimulate the incubation of microbial. The nitrification bioreactor 400 was ready for the preparation of organic liquid fertilizer when the NO₃—N concentration reached to 62 ppm which was regarded as the baseline of experiments.

### Example 3

In this example, the nitrifying efficiency of the bioreactor was studied with different air flow rates. Liquid Fertilizer with NPK value of 10-1-5 was used only in the following experiments. In general, 6 g of the liquid fertilizer was added daily to the bioreactor for 7 successive days. The conditions of the experiments were shown in Table 1. Three levels of air flow rates in three individual tanks: 1.0 nl/m (Tank 1), 3.0 nl/m (Tank 2) and 5.0 nl/m (Tank 3) were studied. The mineralization progress was monitored daily for 8 days by measuring the change of concentration of NO3-N and NH3-H respectively.

TABLE 1
Conditions of the bioreactor with air flow rates of
1.0 nl/m, 3.0 nl/m and 5.0 nl/m respectively.

| Tank no. | 1 | 2 | 3 |
|---|---|---|---|
| Volume of Water (L) | 22 | 22 | 22 |
| Air flow rate (nl/m) | 1.0 | 3.0 | 5.0 |
| Temperature (° C.) | 28-30 | 28-30 | 28-30 |
| Moistened bio-carriers (g) | 1480 | 1480 | 1480 |
| Carolite (g) | 600 | 600 | 600 |

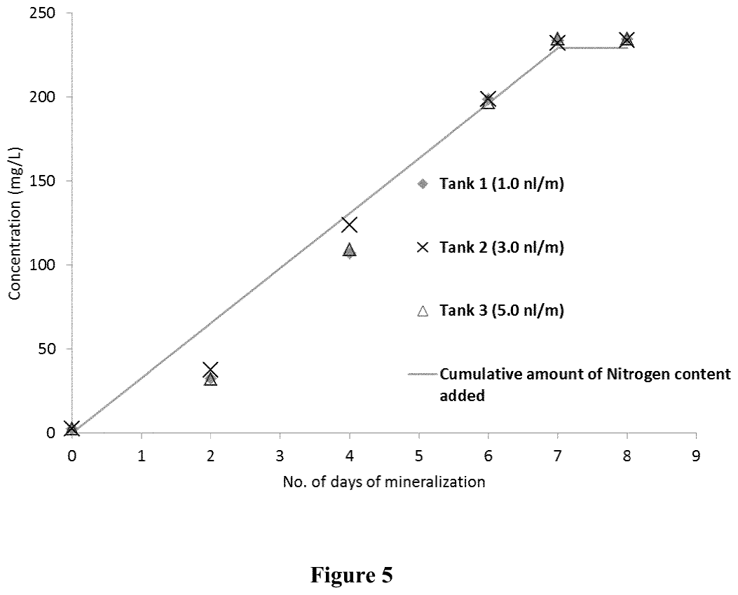

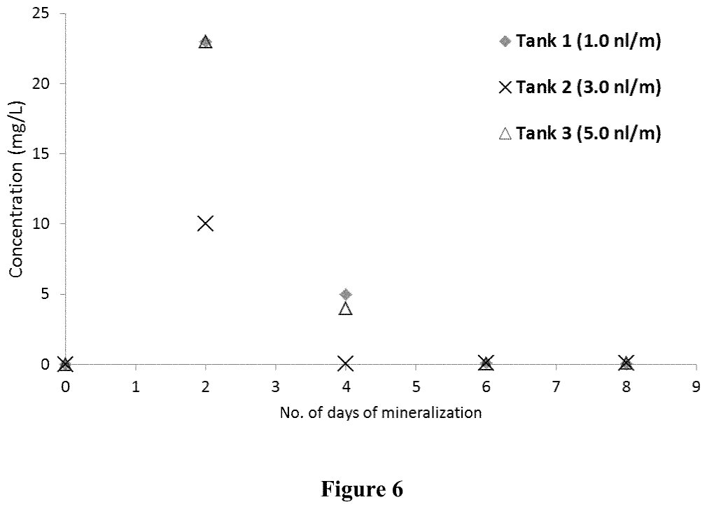

FIG. 5 shows the change of concentration of NO₃—N during 8 day mineralization experiment, while FIG. 6 shows the change of concentration of NH₃—H. Measurements were performed at day 0, day 2, day 4, day 6 and day 8 respectively. The efficiency of the mineralization was evaluated by comparing the concentration of inorganic nitrates with the theoretical concentration of nitrate added to the bioreactor. At day 4, concentration of NO₃—N of each of Tank 1 and Tank 3 were almost the same, i.e. 105 mg/L and 107 mg/L respectively, while concentration in Tank 2 was higher than the others, i.e. 121 mg/L and comparable to the cumulative calculated amount of NO₃—N content (131 mg/L) (Table 2). At day 7 of the mineralization, complete conversion of the organic nitrogen to NO₃—N was observed after 7 days of mineralization for all tanks with different flow rates (Table 3). In conclusion, no difference in conversion efficiency was observed with different air flow rates during 7 day mineralization experiment. Whatever which air flow rate (1, 3, or 5 nl/m) was used, the mineralization process was able to complete in 7 days with total amount of 42 g of Liquid fertilizer.

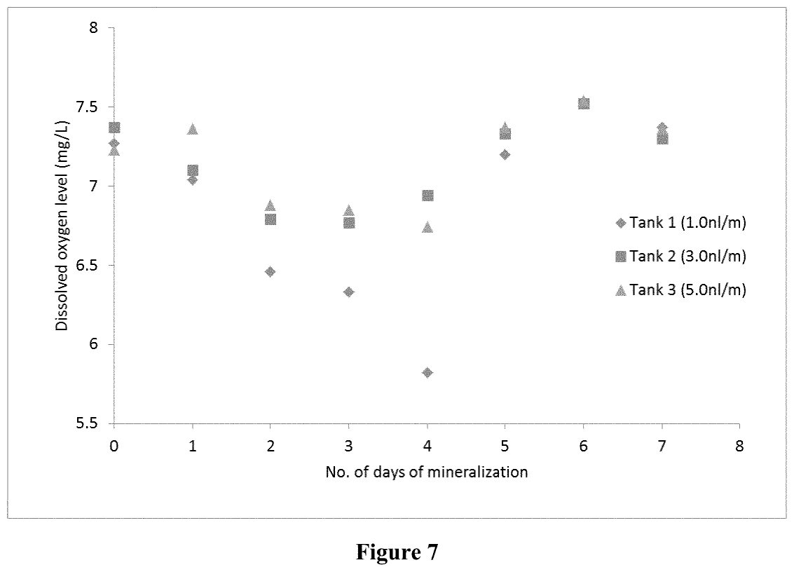

Moreover, dissolved oxygen (DO) level was measured to compare the effects of different air flow rates on the dissolved oxygen during mineralization (FIG. 7). The initial values for all three tanks were almost the same and between 7.2-7.4 mg/L. As mineralization proceeded, the DO level for all the three air flow rates started to drop. At day 3-4, the DO level of Tank 2 (3.0 nl/m) and Tank 3 (5.0 nl/m) dropped to about the same level, i.e. 6.69 mg/L and 6.56 mg/L respectively and bounced back to the level of 7 mg/L and above. However, DO of Tank 1 (1 nl/m) dropped more significantly to below 6.0 mg/L at day 4, but started to increase at day 5. The results showed the air flow rate of 1 nl/m was too low to maintain the DO level at about 7 mg/L or above. On the other hand, that the air flow rate of 3 nl/m was sufficient to maintain a high DO level for the mineralization process as no significant difference on the mineralization efficiency was observed when comparing the experiment results of both air flow rate of 3 and 5 nl/m.

TABLE 2
The amount of NO₃—N increased in mg/L and the
percentage conversion for mineralization with air flow
rates of 1.0 nl/m, 3.0 nl/m and 5.0 nl/m respectively
day 4 of the mineralization process.

| | Tank 1 | Tank 2 | Tank 3 |
|---|---|---|---|
| | (air flow | (air flow | (air flow |
| | rate: 1.0 | rate: 3.0 | rate: 5.0 |
| | nl/m) | nl/m) | nl/m) |
| Amount of NO₃—N | 105 | 121 | 107 |
| increased (mg/L) | | | |
| Percentage conversion | 80 | 92 | 82 |
| (%) | | | |

TABLE 3
The amount of NO₃—N increased in mg/L and the
percentage conversion for mineralization with air flow
rates of 1.0 nl/m, 3.0 nl/m and 5.0 nl/m respectively
at day 7 of the mineralization process.

| | Tank 1 | Tank 2 | Tank 3 |
|---|---|---|---|
| | (air flow | (air flow | (air flow |
| | rate: 1.0 | rate: 3.0 | rate: 5.0 |
| | nl/m) | nl/m) | nl/m) |
| Amount of NO₃—N | 231 | 229 | 232 |
| increased (mg/L) | | | |
| Percentage | 100 | 100 | 100 |
| conversion (%) | | | |

### Example 4

To evaluate the effects of the amount of bio-carriers on the mineralization process, the 7 day experiment with procedures of mineralizing organic nitrogen into nitrate from liquid fertilizer L5 as described in EXAMPLE 3 were carried out with three different amounts of bio-carriers: 0.5 bag (Tank 1, equivalent to 740 g), 1 bag (Tank 2, equivalent to 1480 g) and 1.5 bag (Tank 3, equivalent to 2220 g). Other conditions were kept consistent. The conditions of the experiments were shown in Table 4. The experiment performance was monitored by measurement of the NO₃—N and NH₃—H concentration of the reaction solution.

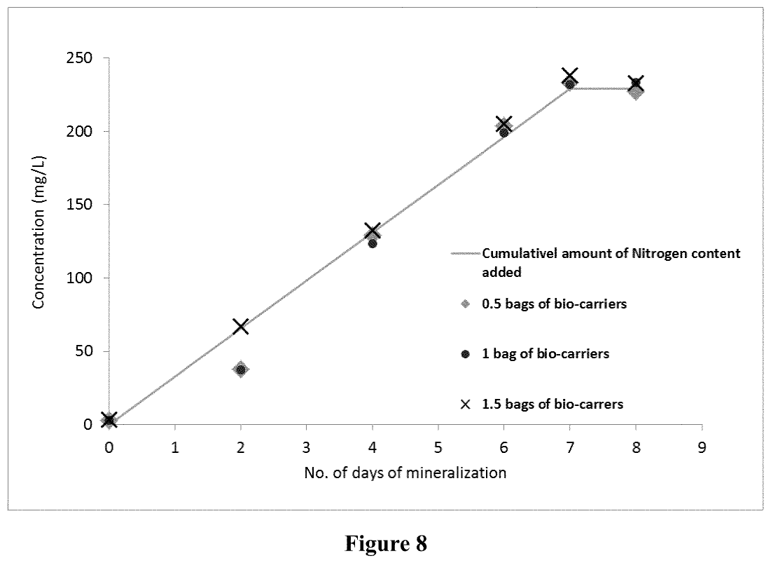

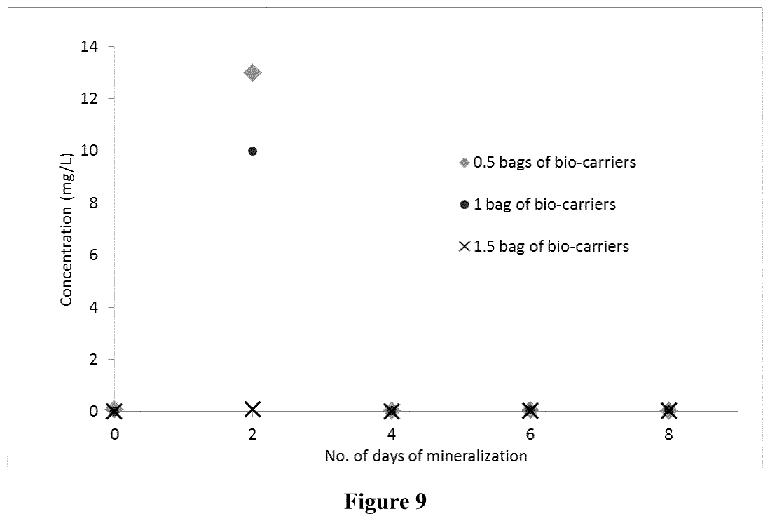

The concentration of NO₃—N and NH₃—H were measured to compare the rates of mineralization with different amount of bio-carriers. FIG. 8 shows the change of concentration of NO₃—N during 7 day mineralization experiment, while FIG. 9 shows the change of concentration of NH₃—H. Measurements were performed at day 0, day 2, day 4, day 6 and day 8 respectively.

TABLE 4
Conditions of the microbial carrier systems with
0.5 bags, 1 bag and 1.5 bags of bio-
carriers respectively.

| Tank no. | 1 | 2 | 3 |
|---|---|---|---|
| Volume of Water (L) | 22 | 22 | 22 |
| Air flow rate (nl/m) | 3.0 | 3.0 | 3.0 |
| Temperature (° C.) | 28-30 | 28-30 | 28-30 |
| Moistened bio- | 0.5 | 1 | 1.5 |
| carriers (bag) | (740 g) | (1480 g) | (2220 g) |
| Carolite (g) | 600 | 600 | 600 |

The evaluation method of the efficiency of mineralization was the same as described in EXAMPLE 3. At day 2, the concentration of NO₃—N of each of Tank 1 and Tank 2 were the same, i.e. 35 mg/L, while the NO₃—N concentration of 64 mg/L of Tank 3 was significantly higher than the other two (Table 5). The result showed that the microbial carrier system with 1.5 bags of bio-carriers was activated in a much shorter time than that with 0.5 and 1 bag of bio-carriers.

TABLE 5
The amount of NO₃—N increased in mg/L and the
percentage conversion for mineralization with 0.5
bags, 1 bag and 1.5 bags of bio-carriers after day
2 of the mineralization process.

| | Tank 1 | Tank 2 | Tank 3 |
|---|---|---|---|
| | (0.5 bags | (1 bag | (1.5 bags |
| | of bio- | of bio- | of bio- |
| | carriers) | carriers) | carriers) |
| Amount of NO₃—N | 35 | 35 | 64 |
| increased (mg/L) | | | |
| Percentage conversion | 54 | 54 | 98 |
| (%) | | | |

At day 7 of the mineralization, complete conversion of the organic nitrogen to NO₃—N was observed after 7 days of mineralization for all tanks with different amount of bio-carriers (Table 6). In conclusion, no difference in conversion efficiency was observed with different amount of bio-carriers during 7 day mineralization experiment. Therefore, 0.5 bag, which is equivalent to 740 g, of bio-carriers was sufficient for the mineralization with 100% efficiency of a total amount of 42 g of Liquid fertilizer L5 in 7 days.

TABLE 6
The amount of NO₃—N increased in mg/L and the
percentage conversion for mineralization with 0.5
bags, 1 bag and 1.5 bags of bio-carriers at day 7
of the mineralization process.

| | Tank 1 | Tank 2 | Tank 3 |
|---|---|---|---|
| | (0.5 bag | (1 bag | (1.5 bag |
| | of bio- | of bio- | of bio- |
| | carriers) | carriers) | carriers) |
| Amount of NO₃—N | 231 | 229 | 235 |
| increased (mg/L) | | | |
| Percentage conversion | 100 | 100 | 100 |
| (%) | | | |

### Example 5

In this example, the general procedure of nitration of organic fertilizer in the bioreactor is described. A liquid fertilizer with NPK value of 10-1-5 was used for demonstration.

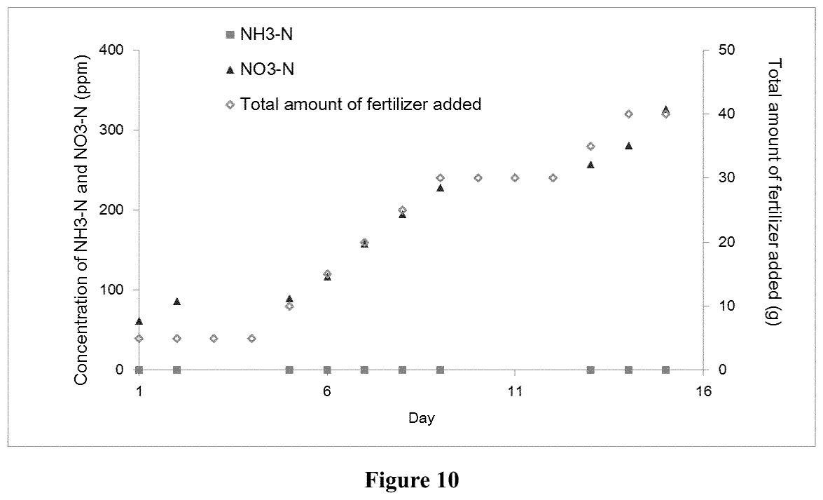

The bioreactor was initiated by adding 1-1.5 mL ammonia solution (28%) daily, excluding weekend and public holiday, in order to stimulate the incubation of microbial. The preparation was started when the NO₃—N concentration reached to 62 ppm which was regarded as the baseline of experiments. 6 g of liquid fertilizer was added daily for 14 successive days excluding weekends and public holidays, and eventually 40 g of fertilizer was added. NO₃—N and NH₃—N contents were monitored on every working day during the preparation period (FIG. 10). Final measured concentration of NO₃—N and NH₃—N were 326 ppm and 0 ppm respectively.

### Example 6

The finalized formulation of the microbial enhanced organic liquid fertilizer (OLF) was used to verify the growth of lettuces. Three parallel hydroponics experiments with OLF, chemical fertilizers (CF) and undigested organic liquid fertilizer (Undigested OLF) were carried out for the following objectives: To verify the final harvest of the hydroponics of leafy green cultivars using OLF is comparable with that using chemical fertilizers (CF); To verify the OLF developed will have productivity improvement of 70% or more compared with the organic fertilizer without microbial enhancement.

Commercially available lab-scale hydroponics machines with automatic air pump and LED lighting system was used for the hydroponic study. 8 plants were grown in each hydroponic machine. 3 L of nutrient solution was used for each hydroponic tank unless stated otherwise. The LED system was programmed to turn on at 7:00 am and off at 7:00 pm every day. Initial pH value of the nutrient solution was controlled within the range of 5.5-6, and the pH value would increase gradually due to the release of hydroxide ions to balance the ionic environment when the plant absorbed NO₃⁻ ions. The pH value should never be over 7. Temperature for hydroponics was controlled between 24-25° C. by an independent air conditioning in an enclosed area. OLF was prepared by the microbial mineralization in the bioreactor with the nutrient content as shown in Table 7. CF was prepared by in situ addition of the stock solution A and B (Table 8) into tap water (3 L) to give the nutrient solution for hydroponics with the nutrient content as same as OLF. Undigested OLF was prepared by adding liquid organic fertilizer with NPK value of 10-1-5 (4.6 g) in tap water (3 L) in which theoretically contained equivalent amount of nitrogen.

TABLE 7
Standard reference formulations for the preparation
of OLF for hydroponics of leafy green cultivars.

| | Concentration (ppm) |
|---|---|
| | Sonneveld's Recipe for |
| Element | Leafy Green Cultivars |
| Nitrogen (N) | 150 |
| Phosphorus (P) | 31 |
| Potassium (K) | 210 |
| Calcium (Ca) | 90 |
| Magnesium (Mg) | 24 |
| Iron (Fe) | 1 |
| Manganese (Mn) | 0.25 |
| Zinc (Zn) | 0.13 |
| Boron (B) | 0.16 |
| Copper (Cu) | 0.023 |
| Molybdenum (Mo) | 0.024 |

TABLE 8
Formulations for preparing 1 litre of each the chemical
nutrient stock solution for leafy green cultivars.

| Stock solution A | | Stock solution B | |
|---|---|---|---|
| | Weight | | Weight |
| Chemical name | (g) | Chemical name | (g) |
| Calcium nitrate | 52.7 | Potassium phosphate | 13.62 |
| tetrahydrate | | monobasic (KH₂PO₄) | |
| (Ca(NO₃)₂ · 4H₂O) | | | |
| Ammonium nitrate | 3.81 | Magnesium sulfate | 24.63 |
| (NH₄NO₃) | | heptahydrate | |
| | | (MgSO₄ · 7H₂O) | |
| Potassium nitrate (KNO₃) | 44.26 | Manganese sulfate | 0.077 |
| | | heptahydrate | |
| | | (MnSO₄ · 7H₂O) | |
| Ethylenediaminetetraacetic | 0.22 | Boric acid (H₃BO₃) | 0.093 |
| acid monosodium | | | |
| ferric salt hydrate | | | |
| (Fe-EDTA) | | Sodium molybdate | 0.0061 |
| | | dihydrate | |
| | | (Na₂MoO₄ · 2H₂O) | |
| | | Zinc sulfate heptahydrate | 0.057 |
| | | (ZnSO₄ · 7H₂O) | |
| | | Copper (II) sulfate | 0.0093 |
| | | pentahydrate | |
| | | (CuSO₄ · 5H₂O) | |

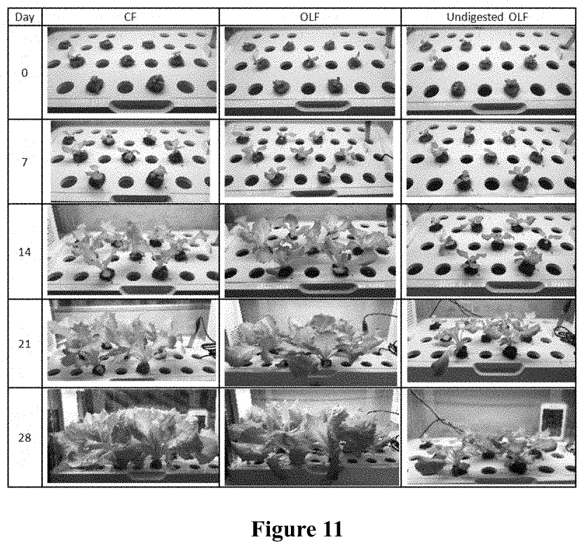

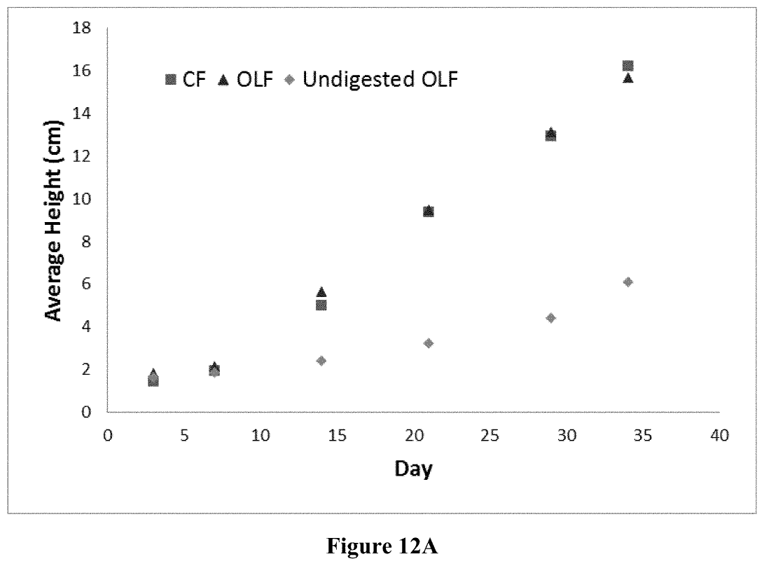

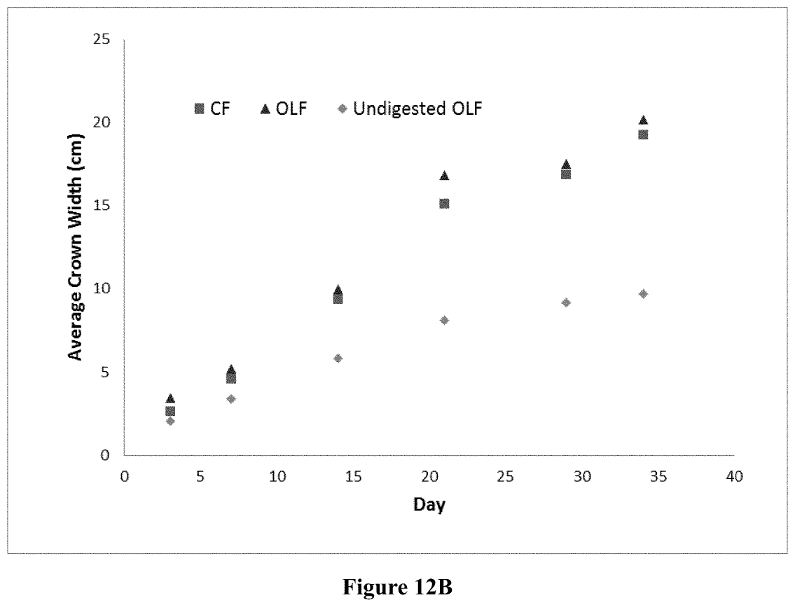

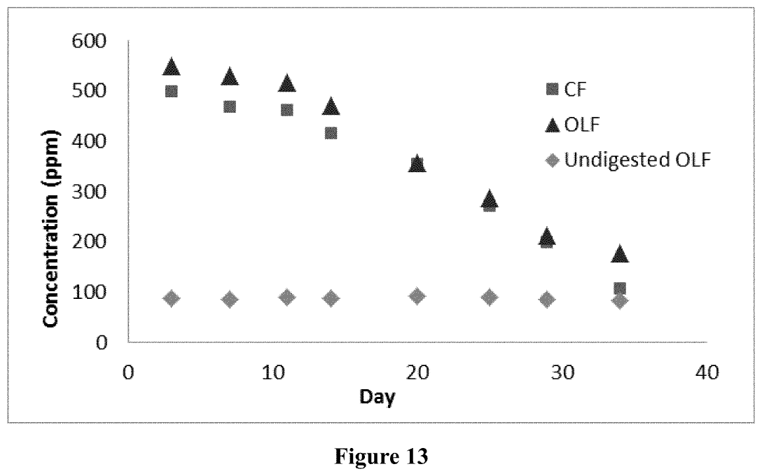

Local lettuce was the cultivar used in this study. Healthy seedlings of lettuces were transplanted to each of hydroponics machine with CF, OLF undigested OLF respectively (FIG. 11). After 34 days of the hydroponics, 183 g and 210 g of local lettuces were harvested from the hydroponics with CF and OLF respectively. However, only 18 g of lettuces was harvested from undigested OLF. The growth rate of the lettuces was also represented by the average height and crown width recorded periodically (FIGS. 12A and 12B), and the total macro nutrient consumption rate (FIG. 13).

The overall weight, average height and average crown width of local lettuces harvested from OLF were comparable with those harvested from CF, which meant the microbial enhanced OLF was able to be used as the nutrient solution for hydroponics of lettuces without addition of chemical type fertilizers. On the other hand, stunting was observed on lettuce grown from undigested OLF resulting the very small amount of the harvest comparing with those from OLF. Therefore, the productivity efficiency of the hydroponics of local lettuces is vastly improved by 11 times in term of weight of the final harvest.

### Example 7

In this example, two organic acid producing Bacillus species, namely Bacillus megaterium and Bacillus subtilis, were tested for their ability in solubilizing phosphorus from bone meal which was a high phorphorus content organic material. The bacteria were procured from the Leibniz Institute DSMZ. The bacteria were first cultivated in medium solution for 4 days as pre-cultures. Referring to FIG. 4B, a phosphorus solubilization bioreactor 500 comprising a tank 510 containing a medium solution 511 was provided. The medium solution 511 contained 10 g glucose; 0.5 g (NH₄)₂SO₄; 0.2 g NaCl; 0.1 g MgSO₄.7H₂O; 0.2 g KCl; 0.002 g MnSO₄.H₂O; 0.002 g FeSO₄.7H₂O; 0.5 g yeast extract per liter of distilled water. Phosphorus solubilization of bone meal by each bacterium was carried out in the phosphorus solubilization bioreactor 500 by transferring 10% (v/v) of the pre-culture to the medium solution, adding 5 g/L of bone meal and cultivating for 4 days at 34° C., with shaking at 120 rpm. Phosphorus solubilization of 5 g/L of tricalcium phosphate which acted as an inorganic phosphorus source was also carried out for each bacterium as control experiments. The pH and the dissolved phosphorus content were measured at the start and at the end of 4 days of phosphorus solubilization.

Table 9 summarizes the results of phosphorus solubilization by the two Bacillus species. It can be seen that there were significant amounts of dissolved phosphorus being released for all conditions after 4 days of phosphorus solubilization and there were corresponding drops in pH. The highest amount of dissolved phosphorus was released by B. subtilis with bone meal, which was 163 mg/L (33% of the added phorphorus content). This amount was a few times higher than the common phosphorus requirement in hydroponics (30-50 mg/L).

TABLE 9
The change of pH and dissolved phosphorus content after 4
days of phosphorus solubilization of bone meal and tricalcium
phosphate by B. megaterium and B. subtilis

| | Day 1 (Initial) | | Day 5 | | |
|---|---|---|---|---|---|
| | | Dissolved | | Dissolved | Dissolved P/ |
| | pH | P (mg/L) | pH | P (mg/L) | added P (%) |
| Medium, | 6.25 | 6 | 4.75 | 103 | 21 |
| B. megaterium, | | | | | |
| Tricalcium phosphate | | | | | |
| Medium, | 6.45 | 5 | 5.65 | 122 | 25 |
| B. megaterium, | | | | | |
| Bone meal | | | | | |
| Medium, | 6.17 | 6 | 5.03 | 82 | 17 |
| B. subtilis, | | | | | |
| Tricalcium | | | | | |
| phosphate | | | | | |
| Medium, | 6.47 | 5 | 5.32 | 163 | 33 |
| B. subtilis, | | | | | |
| Bone meal | | | | | |

The present disclosure further provides another method for producing a microbial-enhanced organic liquid fertilizer for hydroponic cultivation according to certain embodiments.

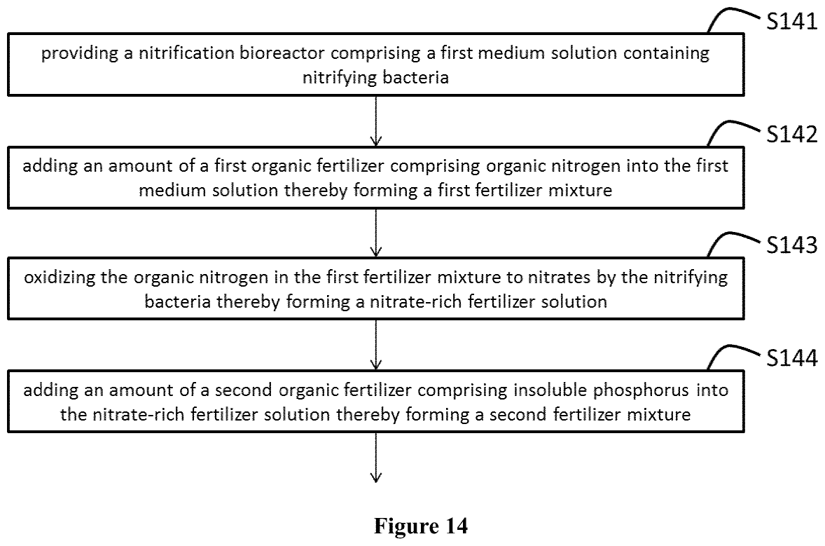

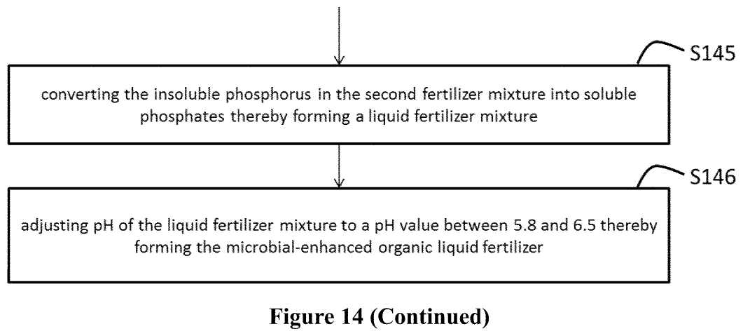

FIG. 14 is a flow chart depicting a method for producing a microbial-enhanced organic liquid fertilizer for hydroponic cultivation according to certain embodiments. In step S141, a nitrification bioreactor comprising a first medium solution containing nitrifying bacteria is provided. In step S142, an amount of a first organic fertilizer comprising organic nitrogen is added into the first medium solution thereby forming a first fertilizer mixture. In step S143, the organic nitrogen in the first fertilizer mixture is oxidized to nitrates by the nitrifying bacteria thereby forming a nitrate-rich fertilizer solution. In step S144, an amount of a second organic fertilizer comprising insoluble phosphorus is added into the nitrate-rich fertilizer solution thereby forming a second fertilizer mixture. In step S145, the insoluble phosphorus in the second fertilizer mixture is converted into soluble phosphates thereby forming a liquid fertilizer mixture. In step S146, a pH adjusting material is added to the liquid fertilizer mixture for adjusting pH of the liquid fertilizer mixture to a pH value between 5.8 and 6.5 thereby forming the microbial-enhanced organic liquid fertilizer.

During the nitration process, the solution pH decreases. On the other hand, the phosphorus solubilization process is promoted by a decrease in the solution pH. Therefore, there is a synergistic effect that the nitration process promotes the phosphorus solubilization process by lowering the solution pH. This synergistic effect is applied in simultaneous nitrification and phosphorus solubilization.

In certain embodiments, the first organic fertilizer is in a form of liquid or solid.

In certain embodiments, the first organic fertilizer comprises livestock excrements, poultry excrements, by-products of food, animal products, fermented leftover food, guano, algae or a combination thereof.

In certain embodiments, the first organic fertilizer has a concentration of organic nitrogen between 5% wt and 10% wt.

In certain embodiments, the organic nitrogen comprises proteins, amino acids, ammonia, or a combination thereof.

In certain embodiments, the nitrifying bacteria comprise Oxalobacteraceae, Nitrospiraceae, Nitrosomonadaceae, Comanmonadaceae, or a combination thereof.

In certain embodiments, the first fertilizer mixture has a pH value between 6 and 8.

In certain embodiments, the first fertilizer mixture has a temperature between 20° C. and 30° C.

In certain embodiments, the method further comprises adding an amount of the first organic fertilizer into the first fertilizer mixture for at least one time at different time intervals.

In certain embodiments, the nitrification reactor further comprises a pH buffer for keeping pH of the first fertilizer mixture at a value between 6 and 8.

In certain embodiments, the nitrification reactor further comprises a bio-carrier for inhabiting and growing the nitrifying bacteria.

In certain embodiments, the second organic fertilizer is in a form of liquid or solid.

In certain embodiments, the second organic fertilizer comprises a bone meal, a fish bone, a phosphate rock, or a combination thereof.

In certain embodiments, the second organic fertilizer has a concentration of insoluble phosphorus between 15% wt and 30% wt.

In certain embodiments, the step of adding an amount of a second organic fertilizer into the nitrate-rich fertilizer is performed when the nitrate-rich fertilizer solution has a pH value between 5.0 and 5.5.

In certain embodiments, the method further comprises: adjusting pH of the second fertilizer mixture to a pH value between 6.0 and 6.5; and adding an amount of the first organic fertilizer to the second fertilizer mixture.

In certain embodiments, the step of adjusting pH of the second fertilizer mixture comprises adding a first pH adjusting material into the second fertilizer mixture.

In certain embodiments, the first pH adjusting material is baking soda or slaked lime.

In certain embodiments, the step of adjusting pH of the liquid fertilizer mixture comprises adding a second pH adjusting material into the liquid fertilizer mixture.

In certain embodiments, the second pH adjusting material is carolite.

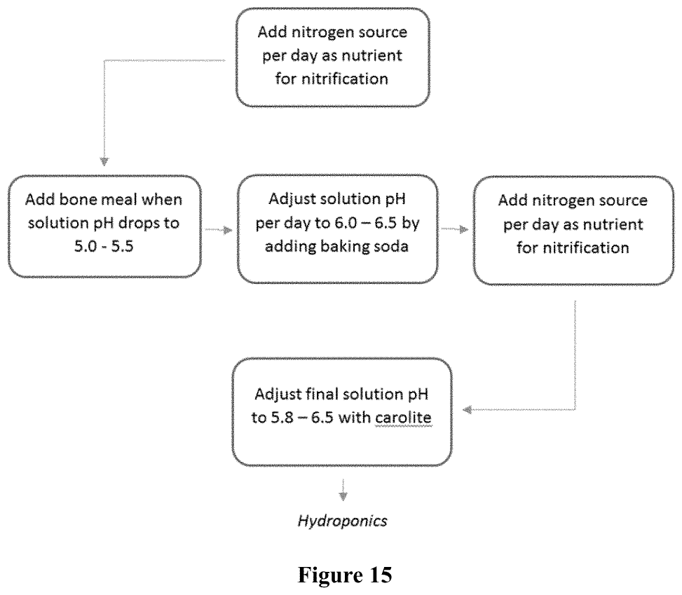

FIG. 15 is a flow chart depicting a method for producing a microbial-enhanced organic liquid fertilizer for hydroponic cultivation according to certain embodiments. This method is directed to the process of simultaneous nitrification and phosphorus solubilization. First, nitrogen source is added per day as nutrient for nitrification. Bone meal is added when solution pH drops to 5.0-5.5. The solution pH is adjusted per day to 6.0-6.5 by adding baking soda. Nitrogen source is added per day as nutrient for nitrification. The final solution pH is adjusted to 5.8-6.5 with carolite to form the microbial-enhanced organic liquid fertilizer for use in hydrophonics.

### Example 8

During nitrification, ammonia is oxidized to form nitrate and in the meantime protons are given out such that the nitrification environment becomes acidic. As a result, it is possible that phosphorus solubilization of insoluble phosphorus materials occurs in the nitrification environment. In this example, the phosphorus solubilization of bone meal in the acidic environment formed by nitrification was tested to verify the feasibility of simultaneous production of nitrate-N and dissolved phosphorus for use as fertilizer in hydroponics. A bioreactor for simultaneous phosphorus solubilization and nitration was fabricated consisting of the following parts: a glass tank (D 22 cm×W 35 cm×H 41 cm), as the container of the mineralization process; 20 L tap water as the medium of mineralization; 985 g of moistened bio-carriers for the inhabitation and growth of the nitrifying bacteria; nitrifying bacteria, the genera Nitrosomonas and Nitrobacter, responsible for the oxidation of ammonia and nitrite respectively; a wave-maker for generating circulation (1585 gallon per hour (GPH)) in the tank water; an air pump supplying air through an air stone to the tank water at a flow rate of 3 nl/m to keep the dissolved oxygen level in the water high for the aerobic mineralization process; A heater for keeping the water at 28-30° C.

A liquid fertilizer with NPK value of 11-1-5 was fed to the bioreactor as a nitrogen source for nitrification. A total amount of 40 g of the liquid fertilizer was added gradually to the bioreactor over 17 days. This amounted to 220 mg/L of nitrogen and 9 mg/L of phosphorus. At the 5^{th} day of the experiment when the pH of the solution had dropped to below 5.5, 100 g of bone meal was added to the bioreactor. At the 22^{nd} day of the experiment, 100 g carol stones were added to adjust the pH of the solution to above 5.5 such that it is suitable for planting. The whole experiment lasted for 25 days. A control experiment was performed without the addition of bone meal to get the amount of any dissolved phosphorus released from added materials other than bone meal.

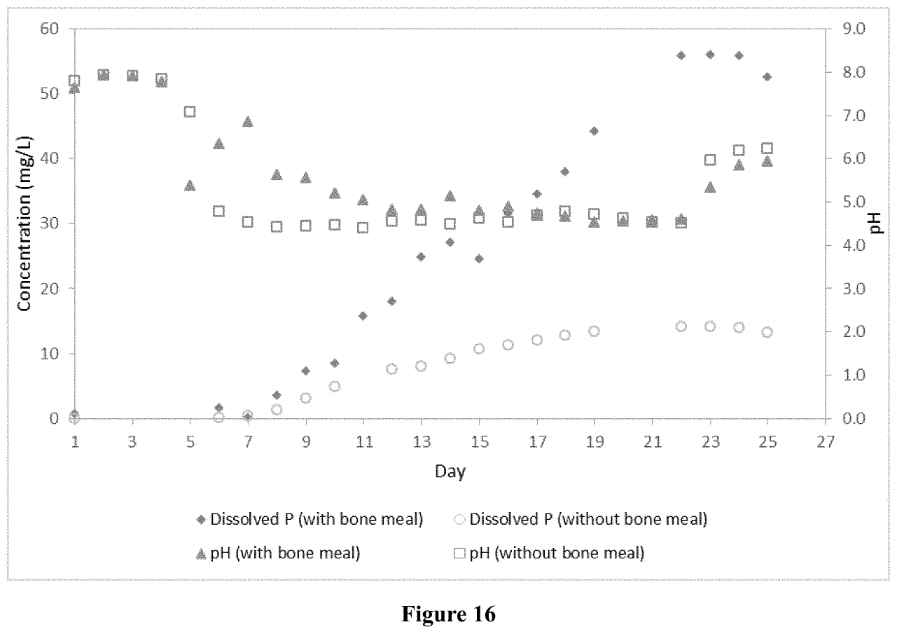

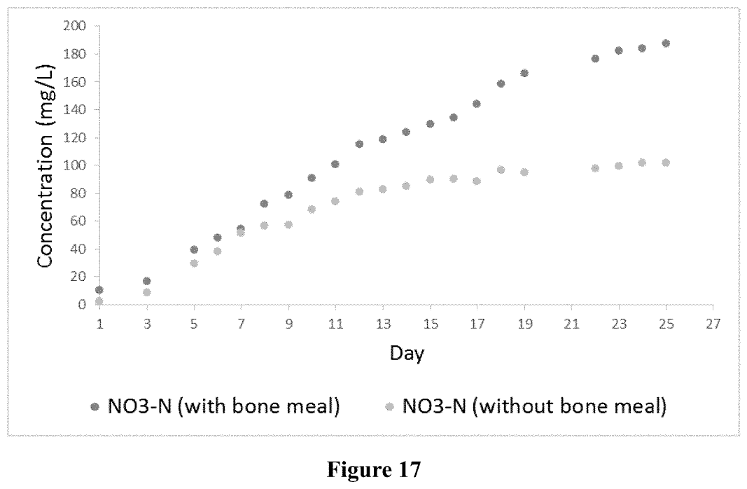

FIG. 16 summarizes the change of dissolved phosphorus and pH over the 25 days of experiments. FIG. 17 summarizes the change of NO₃—N over the 25 days of experiments. From the figures, it can be seen that after the addition of bone meal the pH first rose from 5.5 to 7 from day 5 to day 7 and then dropped back to 5.5 at day 8. After that, the pH dropped gradually to as low as 4.5 and at the same time the content of dissolved phosphorus increased gradually. The highest content of dissolved phosphorus reached was 56 mg/L and the final content of dissolved phosphorus was 53 mg/L. For the control, the pH dropped significantly from 7 to 5 from day 5 to day 6. After that, its pH remained between 4.5 and 5. The highest content of dissolved phosphorus reached was 14 mg/L and the final content of dissolved phosphorus was 13 mg/L. For nitrification, both the experiments with and without bone meal showed gradual increase in nitrate-N. However, the experiment with bone meal added had higher final nitrate-N content (190 mg/L) than that without bone meal added (102 mg/L). It was believed that it was due to the buffering power of bone meal in buffering the pH change during nitrification. The final nitrate-N and dissolved phosphorus content (nitrate-N: 190 mg/L, dissolved P: 53 mg/L) meets the common nutrient requirement for hydroponics.

### Example 9

The availability of soluble phosphorus in solution could be affected by the presence of calcium ions since calcium ions would bind with soluble phosphorus to form insoluble precipitate. Since bio-carriers with high surface areas are made from inorganic materials such as ceramic and glass which contain a significant amount of calcium, calcium ions may be released from them into the solution during nitrification and affect the availability of soluble phosphorus. In order to select the suitable bio-carriers, the effect of three types of bio-carriers on the availability of soluble phosphorus were compared. Their major contents were described in Table 10.

TABLE 10
Description of the major contents of three different bio-carriers

| | Bio-carrier A | Bio-carrier B | Bio-carrier C |
|---|---|---|---|
| Major | Ceramic | Ceramic, | Glass |
| content | | mainly composed of | |
| | | calcium silicate | |

A stock solution of 50 mg/L of soluble phosphorus (a level comparable to common phosphorus content for hydroponics) was prepared by dissolving 0.219 g of Monobasic potassium phosphate in 1000 ml of deionized water. 12 g of each of the three types of bio-carriers was added to three conical flasks separately and 150 ml of the stock solution was distributed to each of the flasks. A control setup was prepared by adding 150 ml of the stock solution to a flask without the addition of any bio-carriers. The flasks were shaken at 100 rpm for seven days. After seven days of shaking, the solution in each of the flasks was filtered by syringe filters with pore size of 22 μm and measured for soluble phosphorus content. The results were summarized in the table below.

TABLE 11
Soluble phosphorus content after seven days of
shaking with three different bio-carriers

| | | Bio-carrier | Bio-carrier | Bio-carrier |
|---|---|---|---|---|
| | Control | A | B | C |
| Final soluble P | 50 | 47 | 0 | 40 |
| content (mg/L) | | | | |

From the results, it can be seen that there was a total loss of soluble phosphorus for Bio-carrier B while a 20% decrease for Bio-carrier C. Bio-carrier A showed the least decrease in soluble phosphorus, which is 6%. Therefore, Bio-carrier A is chosen as the bio-carriers for the nitrification process.

In certain embodiments, pH adjusting materials are used for raising the pH of the nitrification medium which becomes acidic during nitrification so as to keep the pH environment suitable for nitrification. Slaked lime and baking soda are acceptable materials to be used in organic farming that could raise pH. Baking soda which has the chemical composition of sodium bicarbonate is preferred over slaked lime which has the chemical composition of calcium hydroxide since the latter would dissolve in water to give calcium ions that could bind with soluble phosphorus to form insoluble precipitate.

In certain embodiments, carolite could be used as a buffer against pH drop during nitrification. Its function is different from baking soda and slaked lime in that it buffers pH drop rather than raising the pH instantaneously. Since carolite is mainly composed of Calcium carbonate, its amount to be used has to be limited to avoid soluble phosphorus fixed into insoluble forms. Its use in the examples is limited to 30-40 mg/L.

### Example 10

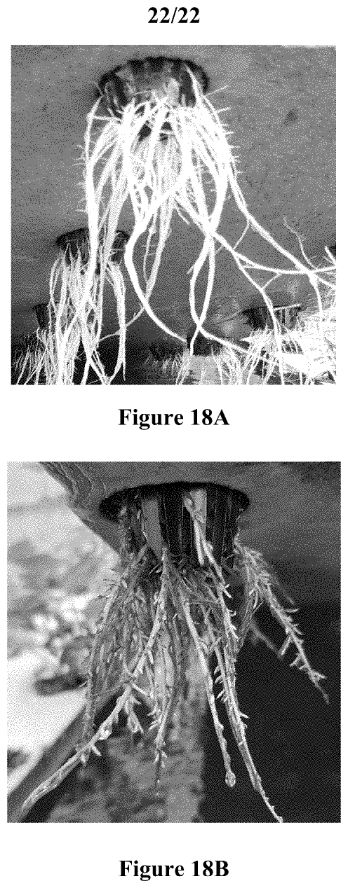

The pH of nutrient solution has to be slightly acidic, i.e. below 6.5 such that ions such as phosphorus and iron are kept in soluble form which can be absorbed by plants. However, too low a pH has adverse effects on plant roots. By hydroponics study of plants grown in different pH, it is found that roots burn at pH below 5.8. Therefore, the produced nutrient solutions are adjusted to pH 5.8-6.5. FIG. 18A shows roots grown at pH 6.0-6.5 being long, thin and light color and FIG. 18B shows roots grown at pH 5.5-5.8 being short, thick and deep color.

Although the invention has been described in terms of certain embodiments, other embodiments apparent to those of ordinary skill in the art are also within the scope of this invention. Accordingly, the scope of the invention is intended to be defined only by the claims which follow.

What is claimed is:

1. A method for producing a microbial-enhanced organic liquid fertilizer for hydroponic cultivation comprising:
providing a nitrification bioreactor comprising a first medium solution containing nitrifying bacteria;
adding an amount of a first organic fertilizer comprising organic nitrogen into the first medium solution thereby forming a first fertilizer mixture;
oxidizing the organic nitrogen in the first fertilizer mixture to nitrates by the nitrifying bacteria thereby forming a nitrate-rich fertilizer solution;
providing a phosphorus solubilization bioreactor comprising a second medium solution containing phosphorus-solubilizing microorganisms;
adding an amount of a second organic fertilizer comprising insoluble phosphorus into the second medium solution thereby forming a second fertilizer mixture;
converting the insoluble phosphorus in the second fertilizer mixture into soluble phosphates by the phosphorus-solubilizing microorganisms thereby forming a soluble-phosphate-rich fertilizer solution;
mixing the nitrate-rich fertilizer solution and the soluble-phosphate-rich fertilizer solution thereby forming a liquid fertilizer mixture; and
adjusting pH of the liquid fertilizer mixture to a pH value between 5.8 and 6.5 thereby forming the microbial-enhanced organic liquid fertilizer.

2. The method of claim 1, wherein the first organic fertilizer is in a form of liquid or solid, comprises livestock excrements, poultry excrements, by-products of food, animal products, fermented leftover food, guano, algae or a combination thereof and has a concentration of organic nitrogen between 5% wt and 10% wt.

3. The method of claim 1, wherein the organic nitrogen comprises proteins, amino acids, ammonia, or a combination thereof.

4. The method of claim 1, wherein the nitrifying bacteria comprise Oxalobacteraceae, Nitrospiraceae, Nitrosomonadaceae, Comanmonadaceae, or a combination thereof.

5. The method of claim 1, wherein the first fertilizer mixture has a pH value between 6 and 8 and a temperature between 20° C. and 30° C.

6. The method of claim 1, further comprising adding an amount of the first organic fertilizer into the first fertilizer mixture for at least one time at different time intervals.

7. The method of claim 1, wherein the nitrification reactor further comprises a pH buffer for keeping pH of the first fertilizer mixture at a pH value between 6 and 8 and a bio-carrier for inhabiting and growing the nitrifying bacteria.

8. The method of claim 1, wherein the second organic fertilizer is in a form of liquid or solid, comprises a bone meal, a fish bone, a phosphate rock, or a combination thereof and has a concentration of insoluble phosphorus between 15% wt and 30% wt.

9. The method of claim 1, wherein the phosphorus-solubilizing microorganisms comprise Bacillus megaterium, Bacillus subtilis, Bacillus cereus, or a combination thereof.

10. The method of claim 1, wherein the second fertilizer mixture has a pH value between 4.0 and 5.5 and a temperature between 20° C. and 30° C.

11. The method of claim 1, wherein the step of adjusting pH of the liquid fertilizer mixture comprises adding a pH adjusting material into the liquid fertilizer mixture.

12. The method of claim 11, wherein the pH adjusting material is baking soda or slaked lime.

13. A method for producing a microbial-enhanced organic liquid fertilizer for hydroponic cultivation comprising:
providing a nitrification bioreactor comprising a first medium solution containing nitrifying bacteria;
adding an amount of a first organic fertilizer comprising organic nitrogen into the first medium solution thereby forming a first fertilizer mixture;
oxidizing the organic nitrogen in the first fertilizer mixture to nitrates by the nitrifying bacteria thereby forming a nitrate-rich fertilizer solution;
adding an amount of a second organic fertilizer comprising insoluble phosphorus into the nitrate-rich fertilizer solution thereby forming a second fertilizer mixture;
converting the insoluble phosphorus in the second fertilizer mixture into soluble phosphates thereby forming a liquid fertilizer mixture; and
adjusting pH of the liquid fertilizer mixture to a pH value between 5.8 and 6.5 thereby forming the microbial-enhanced organic liquid fertilizer.

14. The method of claim 13, wherein the first organic fertilizer is in a form of liquid or solid, comprises livestock excrements, poultry excrements, by-products of food, animal products, fermented leftover food, guano, algae or a combination thereof and has a concentration of organic nitrogen between 5% wt and 10% wt.

15. The method of claim 13, wherein the organic nitrogen comprises proteins, amino acids, ammonia, or a combination thereof.

16. The method of claim 13, wherein the nitrifying bacteria comprise Oxalobacteraceae, Nitrospiraceae, Nitrosomonadaceae, Comanmonadaceae, or a combination thereof.

17. The method of claim 13, wherein the first fertilizer mixture has a pH value between 6 and 8 and a temperature between 20° C. and 30° C.

18. The method of claim 13, further comprising adding an amount of the first organic fertilizer into the first fertilizer mixture for at least one time at different time intervals.

19. The method of claim 13, wherein the nitrification reactor further comprises a pH buffer for keeping pH of the first fertilizer mixture at a value between 6 and 8 and a bio-carrier for inhabiting and growing the nitrifying bacteria.

20. The method of claim 13, wherein the second organic fertilizer is in a form of liquid or solid, comprises a bone meal, a fish bone, a phosphate rock, or a combination thereof and has a concentration of insoluble phosphorus between 15% wt and 30% wt.

21. The method of claim 13, wherein the step of adding an amount of a second organic fertilizer into the nitrate-rich fertilizer is performed when the nitrate-rich fertilizer solution has a pH value between 5.0 and 5.5.

22. The method of claim 13 further comprising:
adjusting pH of the second fertilizer mixture to a pH value between 6.0 and 6.5; and
adding an amount of the first organic fertilizer to the second fertilizer mixture.

23. The method of claim 22, wherein the step of adjusting pH of the second fertilizer mixture comprises adding a pH adjusting material into the second fertilizer mixture.

24. The method of claim 13, wherein the step of adjusting pH of the liquid fertilizer mixture comprises adding a pH adjusting material into the liquid fertilizer mixture.

25. The method of claim 24, wherein the pH adjusting material is carolite.
